(19) United States
(12) Patent Application Publication
(10) Pub. No.: US 2014/0350986 A1
(43) Pub. Date: Nov. 27, 2014

(54) SHOWROOM MANAGEMENT METHOD AND SYSTEM

(71) Applicant: FUSION SOFTWARE DEVELOPMENT PTY LTD, Baulkham Hills (AU)

(72) Inventors: Kevin ARNOLD, Baulkham Hills (AU); Carl Arnold, Baulkham Hills (AU)

(73) Assignee: FUSION SOFTWARE DEVELOPMENT PTY LTD, Baulkham Hills (AU)

(21) Appl. No.: 14/287,803

(22) Filed: May 27, 2014

(30) Foreign Application Priority Data
May 24, 2013 (AU) 2013901866

(51) Int. Cl. G06Q 30/06; G06Q 10/10

(52) U.S. Cl. CPC G06Q 30/0641; G06Q 30/0621; G06Q 10/1095
USPC 705/7.19; 705/26.5

(57) ABSTRACT

The present disclosure concerns management of vehicle showrooms. A processor receives user data associated with a user and sends the user data to a database to access a vehicle configuration previously stored in association with the user data, the vehicle configuration being used in a purchase process of a vehicle. The processor then presents a user interface on a screen and presents in the user interface the vehicle configuration to proceed with the purchase process. The user data is sent to a data base to access a vehicle configuration that is presented in the user interface. As a result, the vehicle configuration that was previously stored in the database, such that by a previous visit by the user, is made available and can be presented to the user the second time. The user is not required to remember any of the vehicle configurations and no data needs to be re-entered.

### CROSS-REFERENCE TO RELATED APPLICATIONS

This application claims the benefit of Australia Patent Application AU 2013901866, filed May 24, 2013, and incorporates the Australia Patent Application by reference herein in its entirety.

### FIELD

The present disclosure concerns management of vehicle showrooms.

### BACKGROUND

The statements in this section merely provide background information related to the present disclosure and may not constitute prior art.

A vehicle showroom typically is an open plan room or hall where multiple vehicles, such as cars or boats, are displayed for potential customers to explore those vehicles. It is desirable to make the experience for the potential customer as rich as possible in order to achieve a good number of sales from a given number of potential customers. With increasing combinations of different features, such as wheels and colors, it becomes increasingly difficult to manage the vehicle showroom optimally to achieve these sales figures.

### SUMMARY

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The present disclosure provides a computer-implemented method for vehicle showroom management, comprising:

receiving user data associated with a user;

sending the user data to a database to access a vehicle configuration previously stored in association with the user data, the vehicle configuration being used in a purchase process of a vehicle;

presenting a user interface on a screen; and

presenting in the user interface the vehicle configuration to proceed with the purchase process.

It is an advantage that the user data is sent to a data base to access a vehicle configuration that is then presented in the user interface. As a result, the vehicle configuration that was previously stored in the database, such that by a previous visit by the user, is made available and can be presented to the user the second time. The user is not required to remember any of the vehicle configuration and no data needs to be re-entered.

In client/merchant relationships it is difficult to determine the data that should be accessed to maximise client satisfaction. In the particular case of a vehicle showroom, it was identified that accessing the vehicle configuration that is stored in association with the user data is particularly advantageous. A vehicle configuration is a dynamic data structure that can be accessed and updated by the user to proceed with the purchase process. As a result, accessing the vehicle configuration offers the advantages of addressing exactly those needs that arise in vehicle showroom management.

The computer-implemented method may further comprise:

retrieving from the database stock status data associated with the vehicle configuration; and

presenting in the user interface the stock status data to indicate availability of the vehicle.

The computer-implemented method may further comprise:

retrieving from the database or receiving from the user interface test drive data associated with the vehicle configuration to schedule a test drive; and

presenting in the user interface the test drive data.

The computer-implemented method may further comprise:

retrieving from the database or receiving from the user interface order data associated with the vehicle configuration; and

presenting, based on the order data, in the user interface an order form associated with the vehicle configuration for the user to place an order;

The computer-implemented method may further comprise:

retrieving from the database or receiving from the user interface trade-in vehicle data associated with the vehicle configuration;

determining a discount associated with the vehicle configuration based on the trade-in vehicle data; and

updating the order form in the user interface to include the trade-in vehicle data and the discount.

The computer-implemented method may further comprise:

converting the order form to a digital contract; and

presenting in the user interface the digital contract to be executed by the user.

The computer-implemented method may further comprise:

receiving signature data via the user interface to execute the digital contract; and

storing the executed digital contract in the database in association with the user data to complete the purchase process of the vehicle.

The computer-implemented method may further comprise:

receiving from the user interface a user input changing the vehicle configuration associated with the user data; and

updating the vehicle configuration associated with the user data based on the input data, or generating a new vehicle configuration associated with the user data based on the input data.

The computer-implemented method may further comprise:

retrieving from the database or receiving from the user interface appointment data associated with the user data; and

presenting in the user interface the appointment data to schedule an appointment for the purchase process.

In a second form there is provided a computer software program, including machine-readable instructions, when executed by a processor, causes the processor to perform the method of the first aspect.

In a third form there is provided a computer system for vehicle showroom management, the computer system comprising:

in input port to receive user data associated with a user;

an output port to send the user data to a database to access a vehicle configuration previously stored in association with the user data, the vehicle configuration being used in a purchase process of a vehicle; and

a screen to present a user interface and to present in the user interface the vehicle configuration to proceed with the purchase process.

In a fourth form there is provided a computer-implemented method for vehicle showroom management, comprising:

receiving user data associated with a user;

presenting a user interface on a screen;

receiving from the user interface a user input to form a vehicle configuration associated with the user data;

presenting in the user interface the vehicle configuration; and

storing the vehicle configuration associated with the user data in a database, the vehicle configuration being used in a purchase process of a vehicle.

The computer-implemented method of the fourth form may further comprise:

retrieving from the database stock status data associated with the vehicle configuration; and

presenting in the user interface the stock status data to indicate availability of the vehicle.

The computer-implemented method of the fourth form may further comprise:

receiving from the user interface test drive data associated with the vehicle configuration to schedule a test drive; and

storing in the database the test drive data associated with the vehicle configuration.

The computer-implemented method of the fourth form may further comprise:

receiving from the user interface order data associated with the vehicle configuration;

presenting, based on the order data, in the user interface an order form associated with the vehicle configuration for the user to place an order; and

storing in the database the order data associated with the vehicle configuration.

The computer-implemented method of the fourth form may further comprise:

receiving from the user interface trade-in vehicle;

determining a discount associated with the vehicle configuration based on the trade-in vehicle data;

updating the order form in the user interface to include the trade-in vehicle data and the discount; and

storing in the database the trade-in vehicle data associated with the vehicle configuration.

The computer-implemented method of the fourth form may further comprise:

converting the order form to a digital contract; and

presenting in the user interface the digital contract to be executed by the user.

The computer-implemented method of the fourth form may further comprise:

receiving signature data via the user interface to execute the digital contract; and

storing the executed digital contract in the database in association with the user data to complete the purchase process of the vehicle.

The computer-implemented method of the fourth form may further comprise:

receiving from the user interface appointment data to schedule an appointment for the purchase process; and

storing in the database the appointment data in association with the user data.

In a fifth form there is provided a computer software program, including machine-readable instructions, when executed by a processor, causes the processor to perform the method of the fourth form.

In a sixth form there is provided a computer system for vehicle showroom management, the computer system comprising:

in input port to receive user data associated with a user;

a screen to

present a user interface,

receive from the user interface a user input to form a vehicle configuration associated with the user data, and

present in the user interface the vehicle configuration; and

a data store to store the vehicle configuration associated with the user data in a database, the vehicle configuration being used in a purchase process of a vehicle.

Other features described of any form, where appropriate, similarly apply to the other forms also described here.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a mobile computer system for vehicle showroom management;

FIG. 2 illustrates a computer-implemented method for vehicle showroom management;

FIG. 3 illustrates a customer user interface for entering customer information;

FIG. 4 illustrates a beverage selection user interface;

FIG. 5 illustrates a configuration user interface;

FIG. 6 illustrates a stock user interface;

FIG. 7 illustrates a test drive user interface;

FIG. 8 illustrates a trade-in user interface;

FIG. 9 illustrates a trade-in valuation user interface;

FIG. 10 illustrates an order and trade-in user interface;

FIG. 11 illustrates a quotation in user interface; and

FIG. 12 illustrates a contract user interface.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

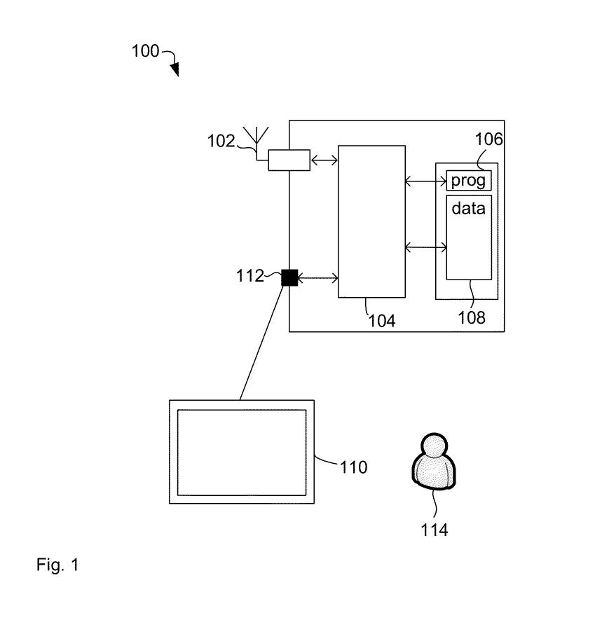

FIG. 1 illustrates a mobile computer system 100, such as a tablet computer. The tablet computer 100 may be an Apple iPad, Samsung Galaxy or any other tablet computer. The tablet computer 100 comprises a network interface 102 connected to a processor 104. The processor 104 is further connected to program memory 106, data memory 108 and to display 110 via display port 112. A sales person 114, operates the tablet computer 100 to access and view a vehicle configuration or a video of the vehicle and show this content to a user, such as a potential customer.

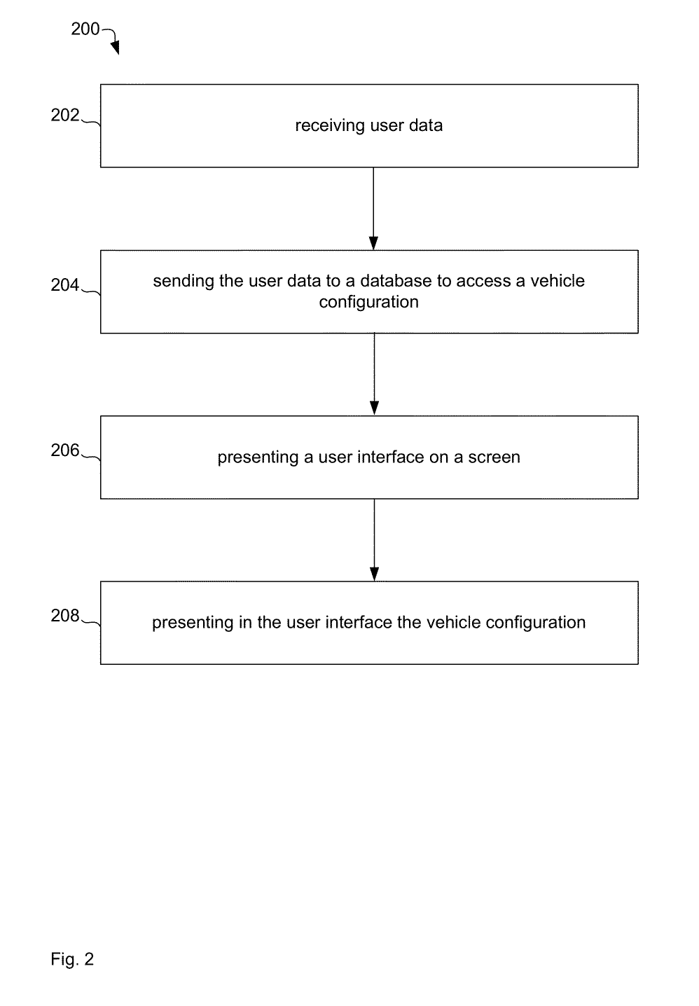

Software, that is an executable program, stored on program memory 106 causes the processor 104 to perform the method in FIG. 2, that is, the processor 104 receives customer data, sends the customer data to a database to access a vehicle configuration, presents user interface on display 110 to sales person 114 and presents the vehicle configuration in the user interface 110.

In one form, the executable program is an app that is installed on the tablet computer 100 via an application provider, such as the Apple's App Store, Google Play or Amazon App Store.

The processor 104 may receive data, such as a vehicle configuration or status data, from data memory 108 as well as from the network interface 102. In some examples, the display is a touch screen display and allows a user to enter data such as by tapping keys on a virtual keyboard displayed on display 110. As a result, the processor 104 further receives data from the display port 112, which is connected to display 110.

It is to be understood that any kind of data port may be used to receive data, such as a network connection, a memory interface, a pin of the chip package of processor 104, or logical ports, such as IP sockets or parameters of functions stored on program memory 106 and executed by processor 104. These parameters may be handled by-value or by-reference in the source code. The processor 104 may receive data through all these interfaces, which includes memory access of volatile memory, such as cache or RAM, or non-volatile memory, such as an optical disk drive, hard disk drive, storage server or cloud storage.

FIG. 2 illustrates a computer-implemented method 200 for vehicle showroom management. This method is performed by processor 104 of mobile tablet computer 100 operated by sales person 114 in the showroom. One difficulty with managing a showroom is that many different potential customers enter the showroom and inquire about different vehicles, such as cars, with different configurations. However, these contacts or leads are not captured and therefore, a returning customer cannot access a previously started purchase process. In the following description a potential customer is simply referred to a customer for the sake of simplicity.

The sales person 114 carries the tablet device and greets customers as they enter the showroom. Of course, showroom management can also reach outdoors in cases where some vehicles are parked on the parking lot in front of the actual showroom building, for example. In these cases, the sales person 114 may greet the customer as the customer enters the parking lot.

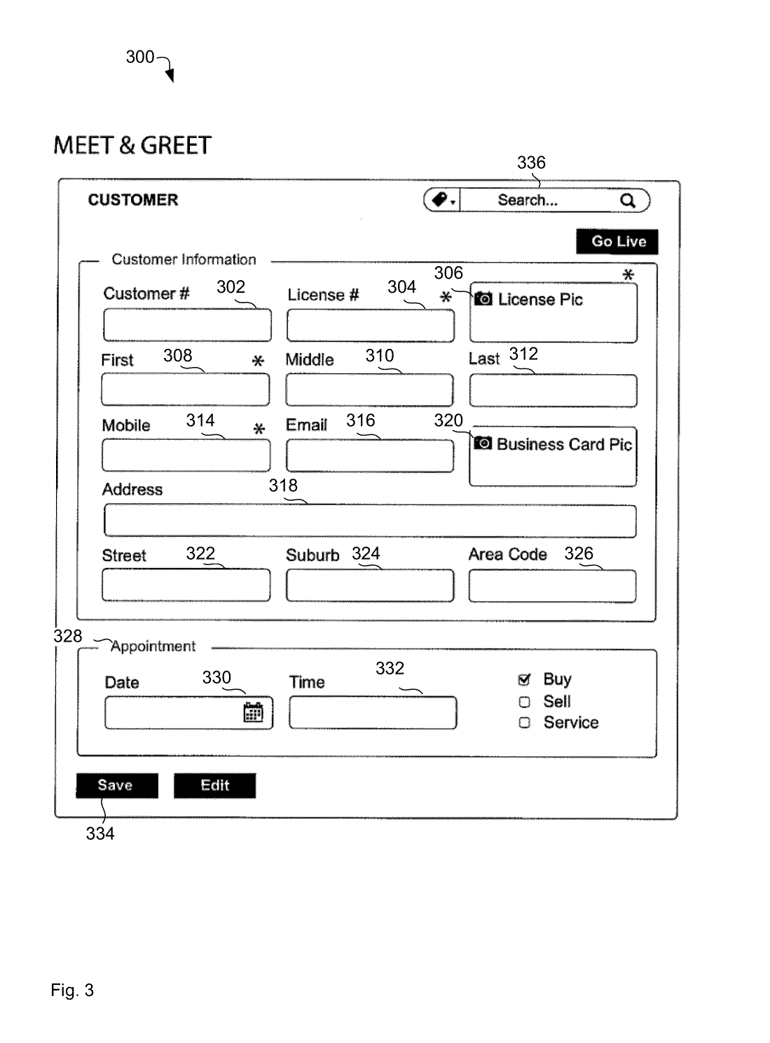

FIG. 3 illustrates a customer user interface 300 for entering customer information. The sales person 114 asks the customer for the customer's personal details and enters this as user data into the user interface 300. The user interface comprises input fields for customer number 302 and license number 304. When the sales person 114 taps on a first camera symbol 306, the tablet computer 100 activates a camera and captures an identity document, such as a driver's license of the customer.

The user interface 300 further comprises input fields for first name 308, middle name 310, last name 312, phone number 314, email address 316 and postal address 318. There is a second camera symbol 320 to activate the camera to capture a business card of the customer. The user interface 300 further comprises appointment input fields 328 comprising a date input field 330 and a time input field 332 to organize an appointment with the customer.

The processor 104 retrieves from the database or receives from the user interface appointment data associated with the user data. The processor 104 then presents the appointment data to schedule an appointment for the purchase process. This means, if the appointment data has been previously stored, the processor 104 retrieves it from the database and populates the interface 300 with the appointment data. For example, when a customer enters the showroom and advises that there is an existing appointment, the sales person 114 can see the appointment data on interface 300. Alternatively, if no appointment data has been stored previously, the processor 104 receives the new appointment data and presents this data in the user interface 300 to schedule an appointment for the purchase process, such as an appointment for a test drive.

In one example, the sales person 114 uses an electronic pen to handwrite quick notes. This makes the contact more personal and can be done standing up or walking through the showroom.

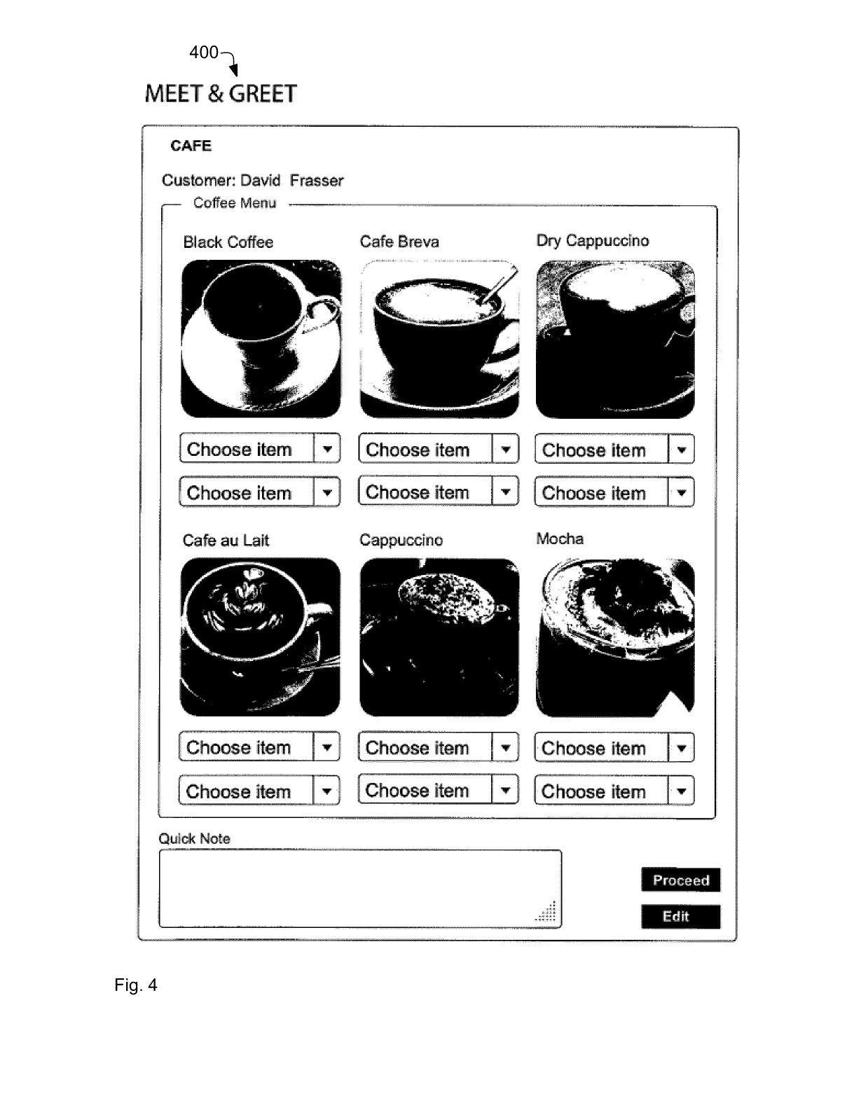

At this stage, the sales person 114 may also order a coffee or other beverage or catering for the customer by selecting a food or drink item on the screen 110. FIG. 4 illustrates a beverage selection user interface 400. The processor 104 sends this order to the catering service, such as a bar, which can then prepare and serve the requested items.

The screen 110 may further display an interface for a needs analysis. This analysis comprises a set of questions and the answers to these questions narrows down the set of suitable vehicles. These questions may be related to whether the vehicle will be used for a family, to take a dog on holidays or whether a seven seater is required.

Referring back to FIG. 2, as the sales person 114 enters the user data that is associated with the customer, the processor 104 receives 202 the user data that is entered into the user interface 300. Once the sales person 114 completes the entering of the data, such as by tapping a save button 334 in FIG. 3, the processor 104 sends the user data to a database. In one example, the processor 104 sends the user data via a Wifi network that is managed by the showroom operator to a database that is hosted by the showroom operator.

Of course, a car manufacturer may have many showrooms at different locations and there may be a single database for all showrooms. The communication between multiple tablet computers and the database may then be via a combination of Wifi and the Internet over a secure connection, such as VPN.

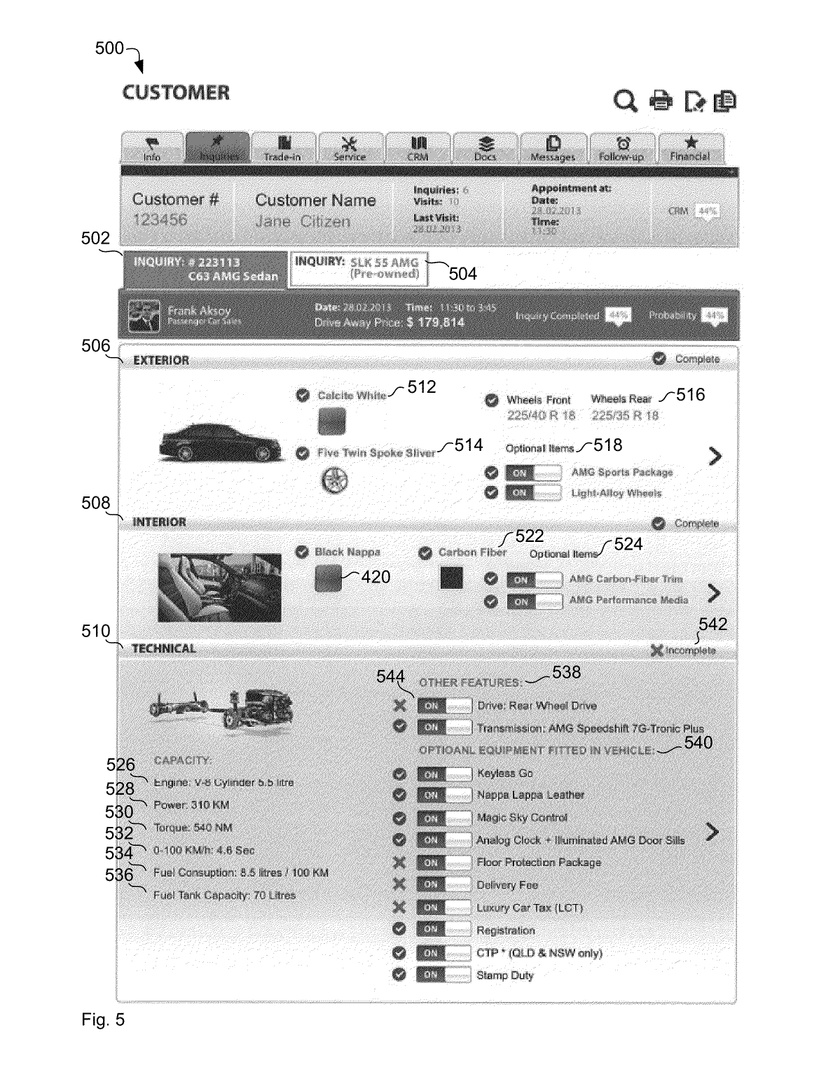

The database has previously stored a vehicle configuration in association with the customer data. That is, the customer is returning for a second visit and the vehicle configuration is used in a purchase process of a vehicle. A vehicle configuration may comprise data that characterises a particular vehicle, such as brand, model, engine, color and extras. An example of a vehicle configuration can be seen in FIG. 5, which will be referred to later. A vehicle configuration may be incomplete, for example, may only comprise the model name and no further information.

The database receives the user data and queries the stored data records for a matching user. For example, the sales person 114 may enter the phone number into a search field 336 in FIG. 3 and the processor 104 sends the phone number to the database. The database then queries the stored records of customers for the entered phone number and identifies the customer with a respective customer identifier that is unique for this customer. The database returns the stored customer data, such as the customer name and address to the tablet computer 100 and the tablet computer automatically populates the user interface 300 with the received customer data. This way, the sales person 114 does not need to re-enter all the customer data when the customer is returning a second time and has already been captured previously.

The processor 104 sends the customer data to the database to access a vehicle configuration previously stored in association with the user data. For example, the customer has previously visited the showroom and showed interest in a Mercedes C63. This interest has been recorded in the database as a vehicle configuration in association with the user ID of the customer, such as an SQL record with the user ID as one data field and the model name as a second data field. When the customer returns the second time, the database receives the customer data from the tablet computer 100, retrieves the previously stored vehicle configuration and sends it to the tablet computer 100. This way, the tablet computer 100 accesses the previously stored vehicle configuration via the database.

The purchase process of a vehicle comprises several steps comprising a first impression of the vehicle in the showroom, preparing a complete configuration, arranging a test drive and executing a purchase or leasing contract. Of course, the purchase process can have more or less steps than this. In any event, the vehicle configuration is used at each step of the purchase process in order to link the purchase to the purchased product, that is, exactly the vehicle that the customer wants to buy.

Once the processor 104 receives the vehicle configuration, processor 104 presents 206 a user interface on screen 110 and presents 208 in the user interface the vehicle configuration to proceed with the purchase process.

FIG. 5 illustrates a configuration user interface 500 that processor 104 presents on screen 110. In this example, the processor 104 accesses a first vehicle configuration 502 and a second vehicle configuration 504 from the database. The sales person 114 can select one of the vehicle configurations 502 or 504 by tapping on the screen 110 at the respective locations.

In this example, the vehicle configuration 502 has an exterior section 506, and interior section 508 and a technical section 510. The exterior section 506 presents exterior configuration features, such as color 512, wheels 514, tires 516 and optional exterior items 518. The interior section 508 presents interior configuration features, such as seat material and color 520, surface finish 522 and optional interior items 524. The technical section 510 presents technical configuration details, such as engine type 526, power 528, torque 530, acceleration 532, fuel consumption 534, fuel tank capacity 526, other technical features 538 and optional technical equipment 540.

The display of the vehicle configuration in user interface 500 may comprise an indicator 542 that particular aspects of the vehicle configuration are missing and need to be completed in order to finalize the purchase process of the vehicle. When the sales person 114 completes the missing aspects, the processor 104 receives from the user interface 500 a user input from the sales person 114, such as tapping on the selection element 544 of the missing rear wheel drive option. The user input changes the vehicle configuration associated with the customer by including or excluding this particular option or my choosing one of multiple alternatives.

The processor 104 updates the vehicle configuration based on the selection, that is, the processor 104 sends the updated vehicle configuration to the database such that the database updates the appropriate records. If no existing vehicle configuration has been recorded previously, the user input causes the processor 104 to create a new vehicle configuration by sending the vehicle configuration to the database as a new record.

At any point in the purchase process, the processor 104 can receive from the database stock status data associated with a vehicle configuration. This means that the processor 104 receives information on whether a vehicle is physically available at the location of the showroom with the exact configuration as provided or with a similar configuration. For example, if the model in the vehicle configuration comprises the term “SLS” the stock status data includes the availability of all vehicles with the term “SLS” in the model.

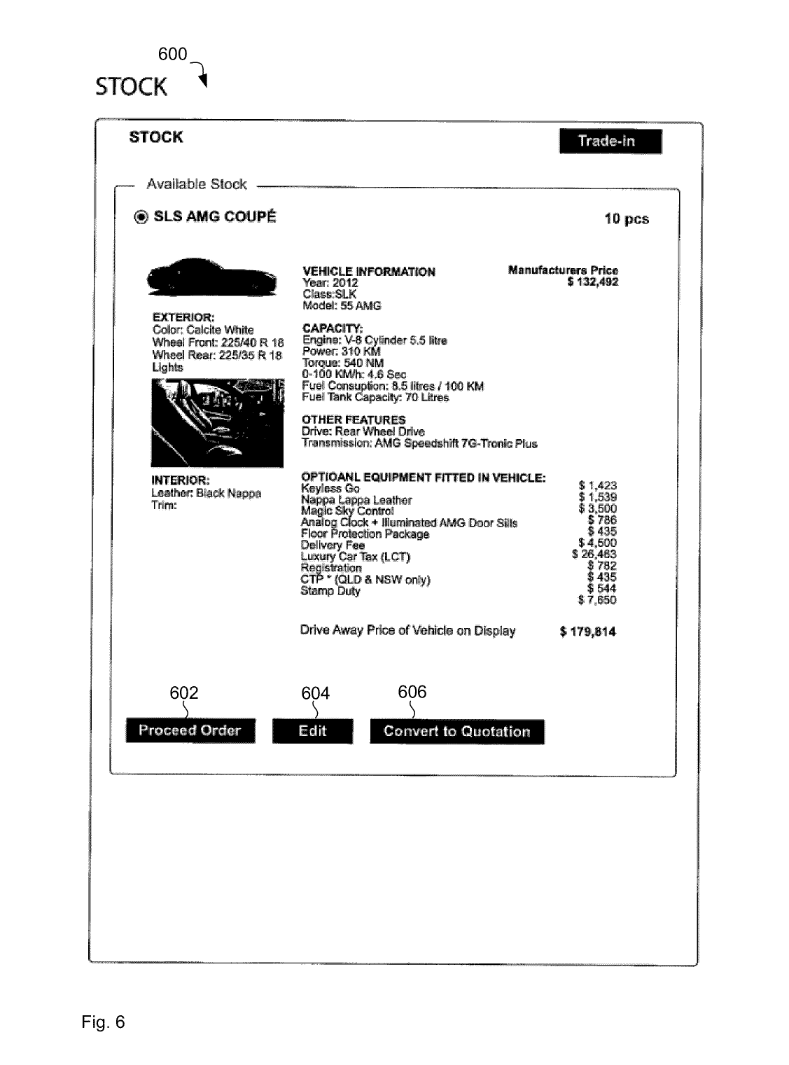

FIG. 6 illustrates a stock user interface 600 where the processor 104 presents the stock status data to indicate the availability of the vehicle and the customer can decide whether to purchase the available vehicle or order a different vehicle if the available vehicle does not provide features that are important to the customer. The stock user interface comprises controls to proceed with an order 602, edit the order 604 and convert this stock information to a quotation 606.

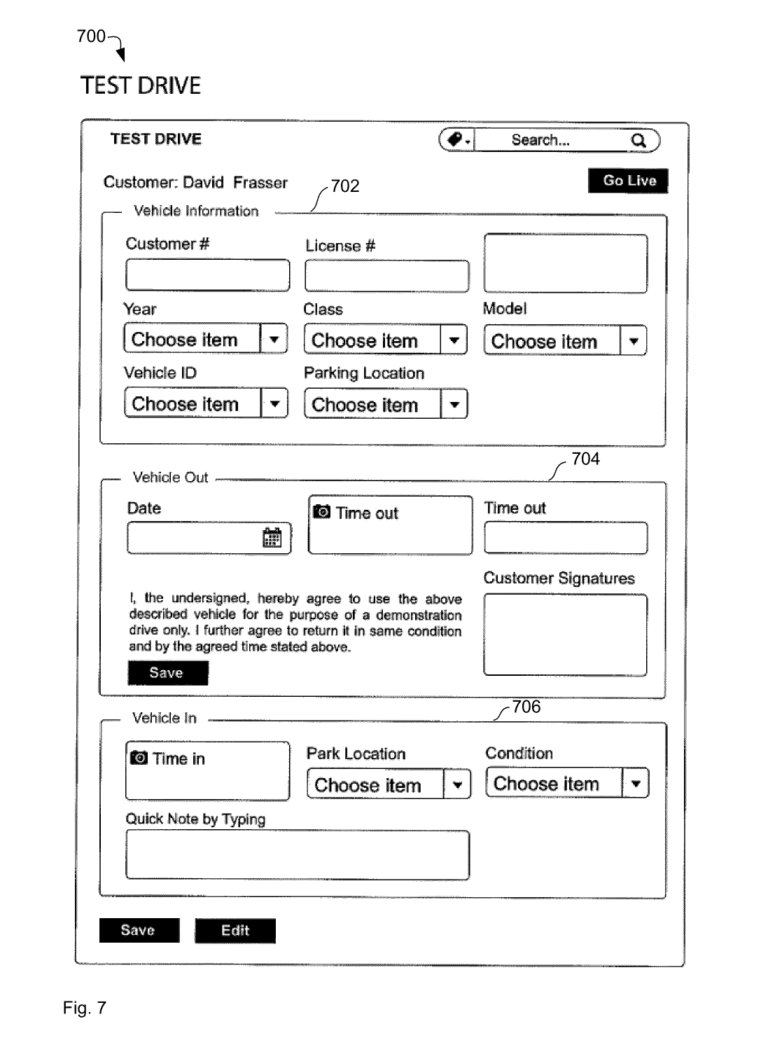

As a next step in the purchase process, the sales person 114 offers the customer a test drive and selects a test drive option on the user interface. FIG. 7 illustrates a test drive user interface 700 before it is populated with data retrieved from the database. The processor 104 retrieves from the database test drive data, such as available vehicles for test driving. The processor 104 may also receive from the user interface 700 test drive data, such as a selection of one of multiple vehicles 702 or a date and time 704 the vehicle is taken out for a test drive. The test drive data is associated with the vehicle configuration such that it is recorded which vehicle the customer takes for a test drive and whether the test drive vehicle corresponds to the vehicle configuration provided earlier. Using the test drive user interface 700, the sales person 114 can also record when the vehicle was returned 706.

In one example, processor 104 records that the configuration of the vehicle in which the customer is interested, such as a sport version Mercedes C-class “C63 AMG”. However, the closest available vehicle for a test drive is a standard C-class vehicle “C300”. Since the processor 104 retrieves the association of the test drive data “C300” with the vehicle configuration information “C63 AMG” the sales person 114 can explain to the customer that the test drive vehicle was not the sport version of the C-class vehicle.

To proceed with the purchase process, the processor 104 retrieves from the database or receives from the user interface order data associated with the vehicle configuration. Order information may comprise an agreed price, payment rates, delivery date, etc. The processor 104 then presents an order form that includes the order data associated with the vehicle configuration. As a result, a returning customer can receive an order contract by providing the customer's name or telephone number and without having to remember the particular details of the vehicle configuration that were stored during the last visit.

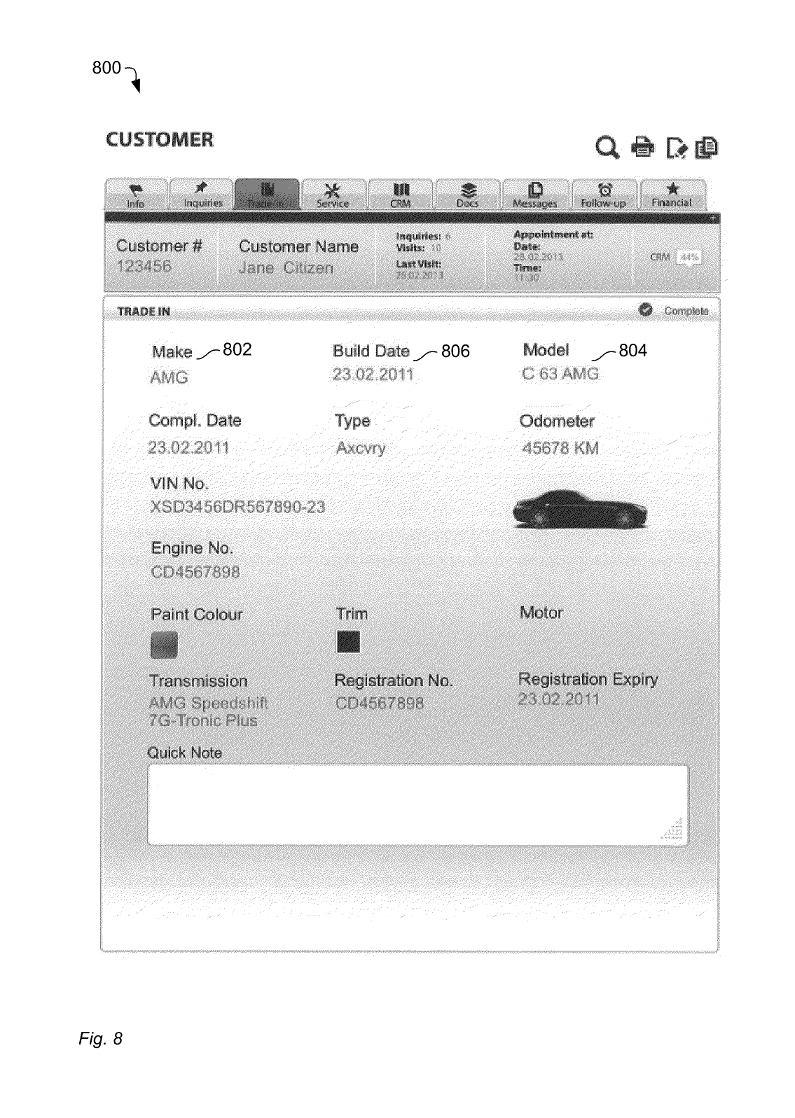

Some customers wish to trade-in their old vehicle and receive a discount on the new vehicle in return. FIG. 8 illustrates a trade-in user interface 800. The processor 104 receives from user interface 800 trade-in vehicle data, such as make 802, build date 804, model 806 and others as shown in FIG. 6.

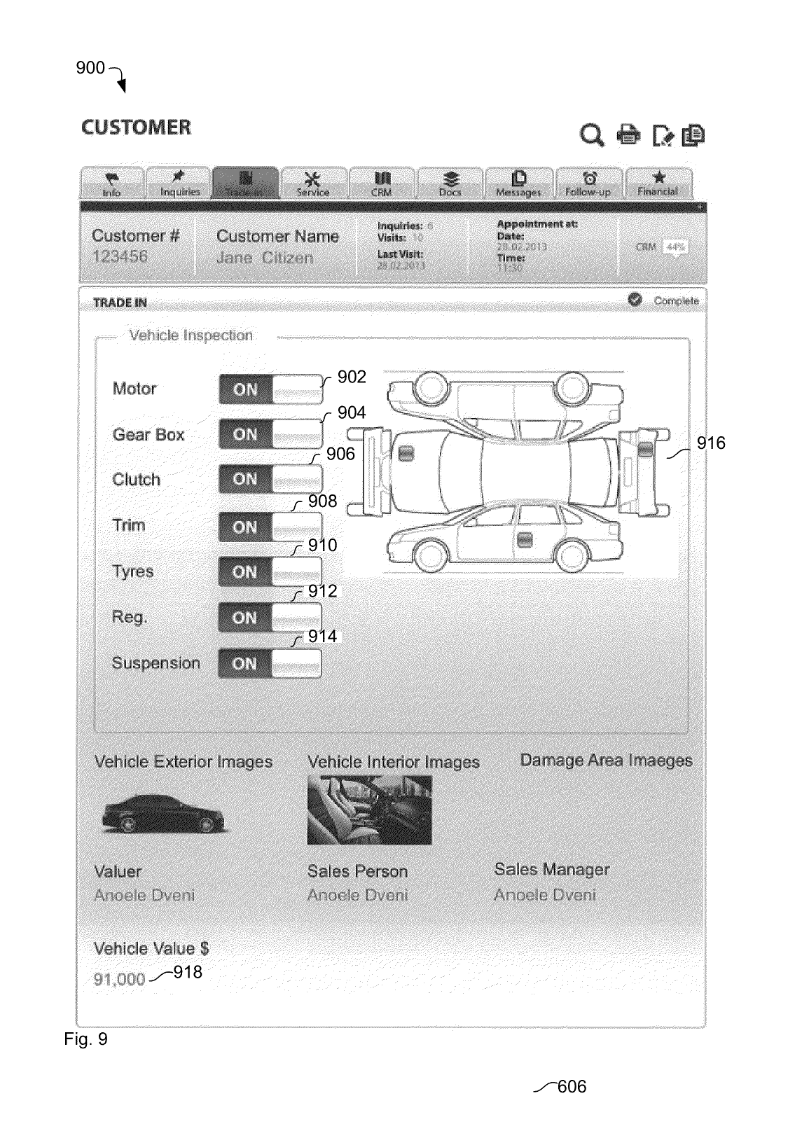

FIG. 9 illustrates a trade-in valuation user interface 900 comprising several elements that assist a valuer in determining the value of a trade-in vehicle. The valuation user interface 900 comprises selection elements similar to a check box such that the valuer can record which aspects of the vehicle were checked. In the example of FIG. 9, the check box comprises elements for motor 902, gear box 904, clutch 906, trim 908, tyres 910, reg. 912 and suspension 914.

The user interface 900 also comprises a damage location map 916 where the locations of existing damages or repairs can me marked, such as by tapping the screen at respective locations on the map 916. Finally, the user interface 900 comprises a vehicle value 918.

The processor 104 may either retrieve previously stored trade-in vehicle data from the database or receive new trade-in vehicle data from the user interfaces 800 and 900. The processor 104 then determines the discount associated with the vehicle configuration based on the trade-in vehicle data. In one example, discount is automatically determined based on technical features of the trade-in vehicle, such as model, engine and damages. The processor 104 may query offers of vehicles that are currently for sale on car sales with a similar specification. In another example, the discount is determined directly based on value 604 of the trade-in vehicle.

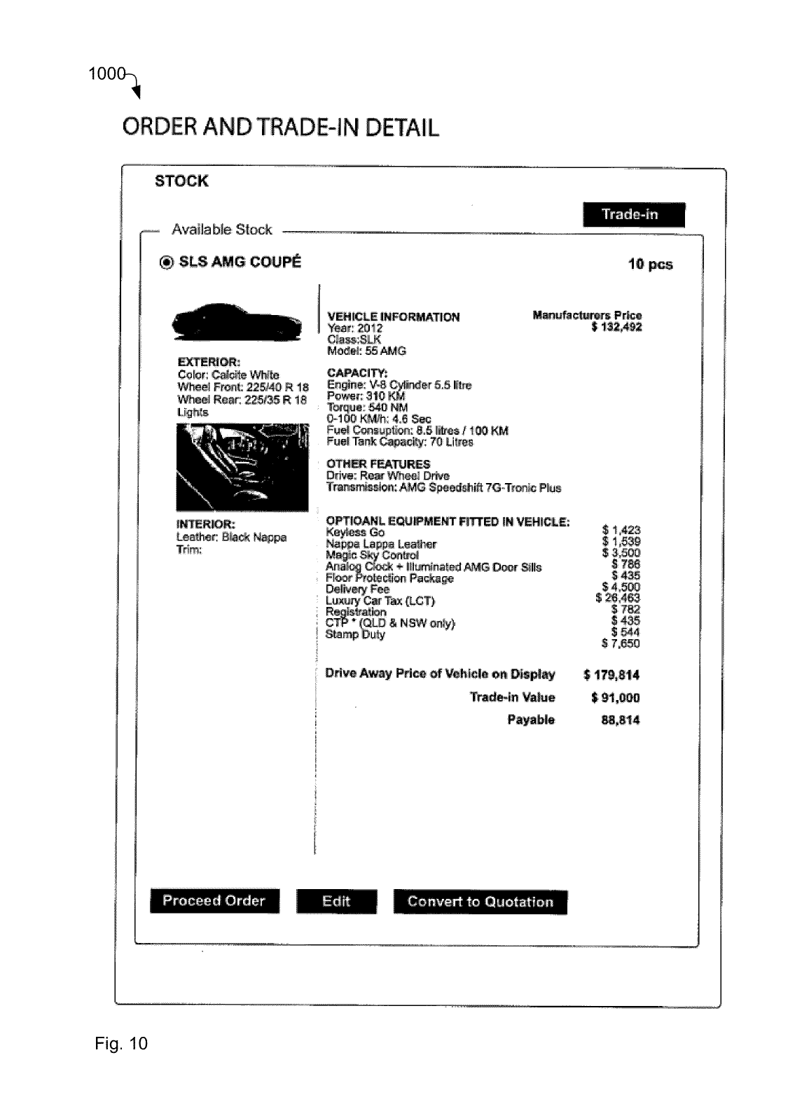

The processor 104 then updates the order form in the user interface to include the trade-in vehicle data and the discount as shown in the order and trade-in user interface 1000 in FIG. 10. That is, the order form specifies the details of the trade-in vehicle and shows the discount and the remaining price of the vehicle to be purchased.

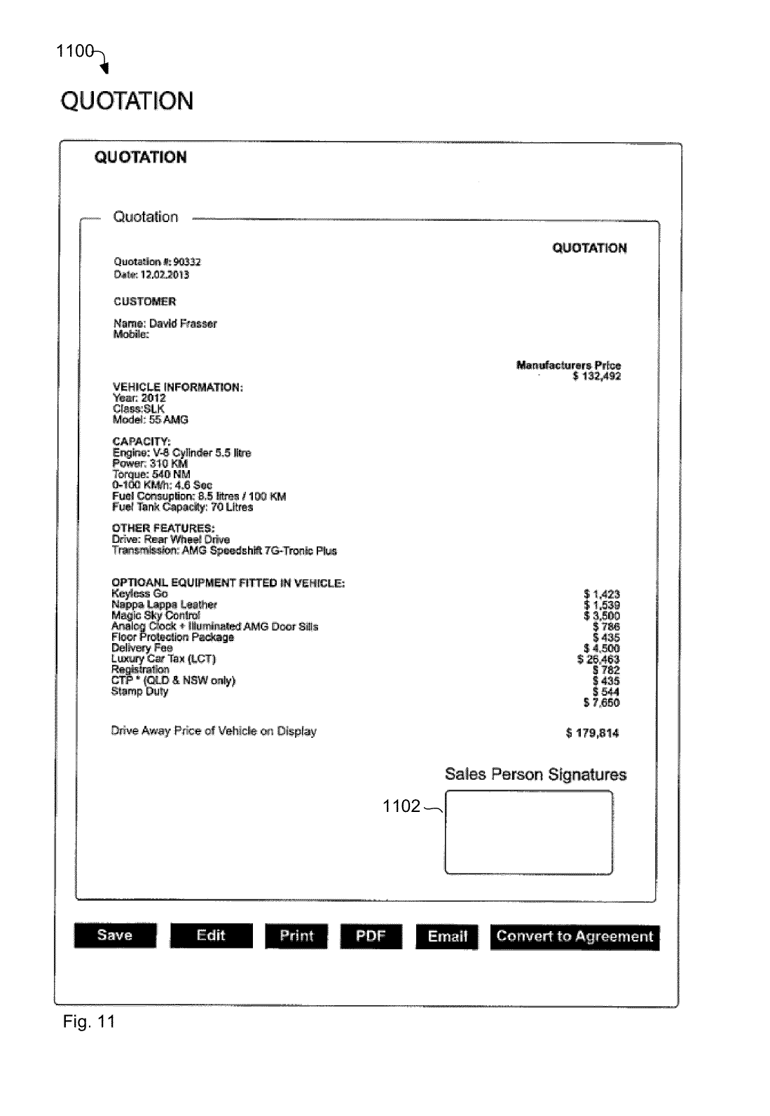

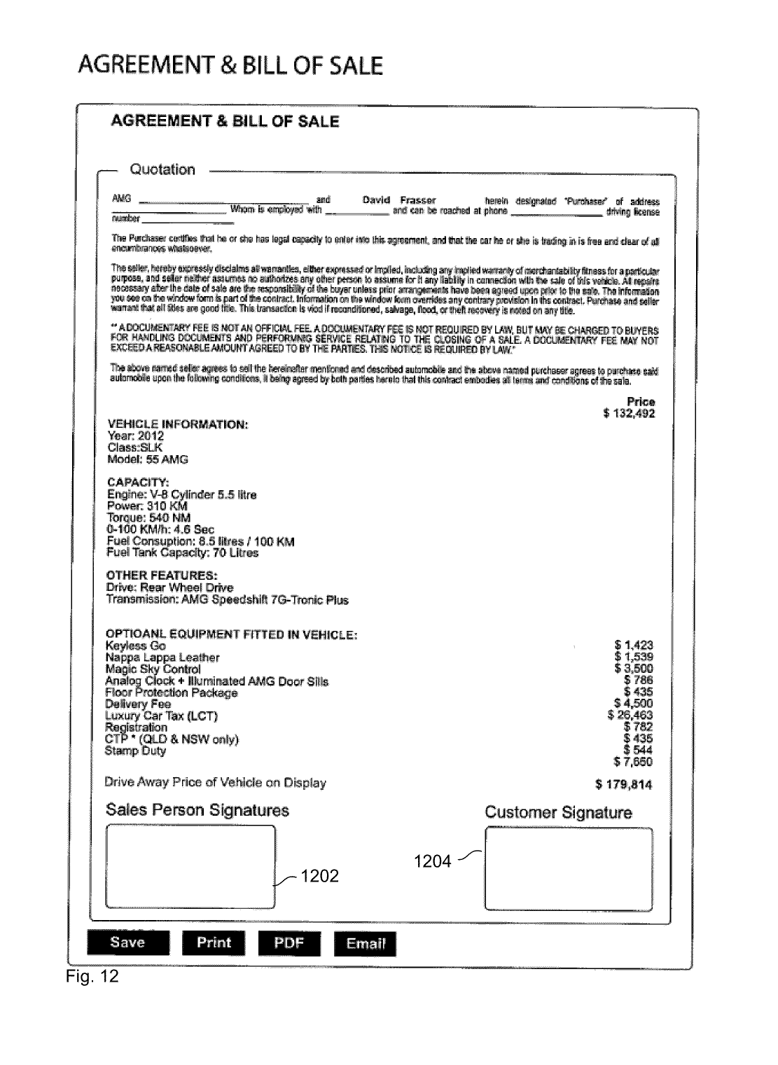

Once the order form is completed, the processor 104 generates a quotation as shown in FIG. 11 that can be signed by sales person 114 using a signature input box 1102. The processor 104 then converts the order form to a digital contract as shown in FIG. 12. The processor 104 presents the digital contract to be executed by the sales person 114 using first signature input field 1202 and by the customer using second signature input field 1204. The order contract may include an agreement on monthly repayments instead of a lump sum payment for the entire amount. When the customer and the sales person 114 sign the contract electronically on the screen 110, the processor receives the signature data, such as an image file in jpg format of the signature and stores the executed digital contract associated with the user data, that is the processor 104 stores the digital contract associated with the signature data to complete the purchase process of the vehicle. In one example, the processor 104 stores the executed contract by sending the contract to the database so that the executed contract is stored in the database.

Both the quotation as well as the digital contract can be exported to pdf or sent to a printer to create a paper copy of the digital contract. Since the user data and the vehicle configuration are available from the previous steps, the digital contract can be generated automatically with little or no additional input from the sales person 114.

It will be appreciated by persons skilled in the art that numerous variations and/or modifications may be made to the present disclosure as shown in the specific forms without departing from the spirit and scope of the present disclosure as broadly described.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “receiving” or “sending” or “obtaining” or “calculating” or “storing” or “determining” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

What is claimed is:

1. A computer-implemented method for vehicle showroom management, comprising:
receiving user data associated with a user;
sending the user data to a database to access a vehicle configuration previously stored in association with the user data, the vehicle configuration being used in a purchase process of a vehicle;
presenting a user interface on a screen; and
presenting in the user interface the vehicle configuration to proceed with the purchase process.

2. The computer-implemented method according to claim 1, further comprising:
retrieving from the database stock status data associated with the vehicle configuration; and
presenting in the user interface the stock status data to indicate availability of the vehicle.

3. The computer-implemented method according to claim 1, further comprising:
retrieving from the database or receiving from the user interface test drive data associated with the vehicle configuration to schedule a test drive; and
presenting in the user interface the test drive data.

4. The computer-implemented method according to claim 1, further comprising:
retrieving from the database or receiving from the user interface order data associated with the vehicle configuration; and
presenting, based on the order data, in the user interface an order form associated with the vehicle configuration for the user to place an order;

5. The computer-implemented method according to claim 4, further comprising:
retrieving from the database or receiving from the user interface trade-in vehicle data associated with the vehicle configuration;
determining a discount associated with the vehicle configuration based on the trade-in vehicle data; and
updating the order form in the user interface to include the trade-in vehicle data and the discount.

6. The computer-implemented method according to claim 4, further comprising:
converting the order form to a digital contract; and
presenting in the user interface the digital contract to be executed by the user.

7. The computer-implemented method according to claim 6, further comprising:
receiving signature data via the user interface to execute the digital contract; and
storing the executed digital contract in the database in association with the user data to complete the purchase process of the vehicle.

8. The computer-implemented method according to claim 1, further comprising:
receiving from the user interface a user input changing the vehicle configuration associated with the user data; and
updating the vehicle configuration associated with the user data based on the input data, or generating a new vehicle configuration associated with the user data based on the input data.

9. The computer-implemented method according to claim 1, further comprising:
retrieving from the database or receiving from the user interface appointment data associated with the user data; and
presenting in the user interface the appointment data to schedule an appointment for the purchase process.

10. A non-transitory computer readable medium with an executable program stored thereon that when executed causes a computer to perform the method of claim 1.

11. A computer system for vehicle showroom management, the computer system comprising:
an input port to receive user data associated with a user;
an output port to send the user data to a database to access a vehicle configuration previously stored in association with the user data, the vehicle configuration being used in a purchase process of a vehicle; and
a screen to present a user interface and to present in the user interface the vehicle configuration to proceed with the purchase process.

12. A computer-implemented method for vehicle showroom management, comprising:
receiving user data associated with a user;
presenting a user interface on a screen;
receiving from the user interface a user input to form a vehicle configuration associated with the user data;
presenting in the user interface the vehicle configuration; and
storing the vehicle configuration associated with the user data in a database, the vehicle configuration being used in a purchase process of a vehicle.

13. The computer-implemented method according to claim 12, further comprising:
retrieving from the database stock status data associated with the vehicle configuration; and
presenting in the user interface the stock status data to indicate availability of the vehicle.

14. The computer-implemented method according to claim 12, further comprising:
receiving from the user interface test drive data associated with the vehicle configuration to schedule a test drive; and
storing in the database the test drive data associated with the vehicle configuration.

15. The computer-implemented method according to claim 12, further comprising:
receiving from the user interface order data associated with the vehicle configuration;
presenting, based on the order data, in the user interface an order form associated with the vehicle configuration for the user to place an order; and
storing in the database the order data associated with the vehicle configuration.

16. The computer-implemented method according to claim 15, further comprising:
receiving from the user interface trade-in vehicle data;
determining a discount associated with the vehicle configuration based on the trade-in vehicle data;
updating the order form in the user interface to include the trade-in vehicle data and the discount; and
storing in the database the trade-in vehicle data associated with the vehicle configuration.

17. The computer-implemented method according to claim 15, further comprising:
converting the order form to a digital contract; and
presenting in the user interface the digital contract to be executed by the user.

18. The computer-implemented method according to claim 17, further comprising:
receiving signature data via the user interface to execute the digital contract; and
storing the executed digital contract in the database in association with the user data to complete the purchase process of the vehicle.

19. The computer-implemented method according to claim 12, further comprising:
receiving from the user interface appointment data to schedule an appointment for the purchase process; and
storing in the database the appointment data in association with the user data.

20. A non-transitory computer readable medium with an executable program stored thereon that when executed causes a computer to perform the method of claim 12.

21. A computer system for vehicle showroom management, the computer system comprising:
an input port to receive user data associated with a user;
a screen to present a user interface and to receive from the user interface a user input to form a vehicle configuration associated with the user data, and said screen presenting in the user interface the vehicle configuration; and
a data store to store the vehicle configuration associated with the user data in a database, the vehicle configuration being used in a purchase process of a vehicle.
